(19) United States
(12) Patent Application Publication
(10) Pub. No.: US 2025/0286498 A1
(43) Pub. Date: Sep. 11, 2025

(54) RAIL-LESS ATTACHMENT ROOF MOUNT

(71) Applicant: Unirac, Inc., Albuquerque, NM (US)

(72) Inventors: Michael Serron, Arvada, CO (US); Jonathan Neal, Albuquerque, NM (US); Casey Ottesen, Albuquerque, NM (US); Vignesh Karthikeyan, Rai Durg (IN)

(21) Appl. No.: 19/068,422

(22) Filed: Mar. 3, 2025

Related U.S. Application Data
(60) Provisional application No. 63/562,201, filed on Mar. 6, 2024.

(51) Int. Cl. H02S 20/23; F16M 13/02

(52) U.S. Cl. CPC H02S 20/23; F16M 13/02

(57) ABSTRACT

A rail-less roof mounting apparatus comprising a clamp assembly including a first clamp portion configured to clamp against a solar panel module and a second clamp portion configured to engage the first clamp portion. The second clamp portion including a fastener section configured to receive a fastener, a clamp support ledge extending in a first direction, and having a first surface configured to engage with the solar panel module. The clamp support ledge having a soft-clamping arm attached to a second surface of the clamp support ledge, and a protrusion having a surface configured to engage with a bottom surface of a second solar panel module. The protrusion extending from the fastener section in a second direction opposite the first direction and a base that is rotatable with respect to the clamp assembly, wherein the fastener extends through the clamp assembly and the base, the fastener engaging a nut therein.

### CROSS REFERENCE TO RELATED APPLICATIONS

This application claims priority to U.S. Provisional Application No. 63/562,201, filed Mar. 6, 2024, the entire disclosure of which is incorporated herein by reference and for all purposes.

### BACKGROUND

As the solar energy industry continues to grow, the equipment to mount solar photovoltaic (PV) modules on different types of structures and/or locations continues to adapt and improve as well. Conventional solar PV module mounting assemblies are frequently designed with a specific use according to a particular surface structure. Current mounting assemblies frequently lack adequate wire management, adequate load strength, and the ability to be implemented on multiple different structures and/or locations. As such, conventional mounting assemblies are overly burdensome to install, often requiring excessive amounts of screws and the manual application of sealant. Despite the numerous existing systems for mounting solar panel modules, there is room for improvement.

Installation of solar PV module mounting assemblies onto a shingled roof presents many challenges. For example, roof shingles are arranged and installed above rafters. Since roof shingles may have various sizes and may be installed above a network of rafters. The various sizes and arrangement of roof shingles over a network of rafters may result in circumstances where shingles may overlap at or near a rafter. Installing a solar PV module mounting assembly on a shingled rooftop that must be mounted to a rafter may be difficult when overlapping shingles create an uneven surface. The uneven surface and proximity of the overlapping shingles relative to the rafters may inhibit the ability for a solar PV module mounting assembly to mount to the rafters.

### BRIEF DESCRIPTION OF THE DRAWINGS

FIG. 1 illustrates a top-front perspective view of a solar panel mounting system, including a rail segment and a mount, according to an embodiment of this disclosure.

FIG. 2A illustrates an isometric side view of a rail-less roof attachment system and a clamp assembly, according to an embodiment of this disclosure.

FIG. 2B illustrates an isometric front view of the rail-less roof attachment system of FIG. 2A with the base rotated 180° relative to the base depicted in FIG. 2A, according to an embodiment of this disclosure.

FIG. 3 illustrates an isometric bottom-side view of a rail-less roof attachment system and a clamp assembly with a single-sided upper portion, according to an embodiment of this disclosure.

FIG. 4 illustrates an isometric bottom-side view of the rail-less roof attachment system and a clamp assembly of FIG. 2A with a double-sided upper portion, according to an embodiment of this disclosure.

FIG. 5 illustrates a close-up of an isometric bottom-side view of the clamping portion of the clamp assembly of FIG. 2A, according to an embodiment of this disclosure.

FIG. 6 illustrates an isometric top view of the rail-less roof attachment system and a clamp assembly of FIG. 2A, according to an embodiment of this disclosure.

FIG. 7 illustrates an isometric back-side view of a rail-less roof attachment apparatus, according to an embodiment of this disclosure.

FIG. 8 illustrates an isometric front-side view of the rail-less roof attachment apparatus of FIG. 7, according to an embodiment of this disclosure.

FIG. 9 illustrates an isometric front view of a rail-less roof attachment system and a clamp assembly, according to an embodiment of this disclosure.

### DETAILED DESCRIPTION

### Overview

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

This disclosure is directed to a rail-less attachment roof system for mounting solar panel modules “direct-to-deck” (e.g., mounting directly to the roof shingles and sheathing as opposed to the raised and/or exposed rafters). Additionally, this disclosure is directed to a rail-less attachment roof system utilizing solar panel module mounts having a “soft-clamp” feature. For example, before a solar panel module is lifted to a roof, the solar panel module mounts may be arranged on a solar panel module at their installation positions and temporarily secured (e.g., soft-clamped) to the solar panel module, which allows the mounts to remain secured against the solar panel module during transportation. When the solar panel module and the soft-clamped mounts are set in position for installation, base of each solar panel mount may be rotated, as needed, while the clamp assembly portion of each solar panel mount remains soft-clamped to the solar panel module. The system and/or one or more components thereof may alternatively be referred to as an apparatus. Features of the system are further described as shown in the figures and expressed in the claims listing.

The structures and features described herein address difficulties associated using a direct-to-deck installation method for installing and sealing a roof mount to a roof without installing and sealing over shingle course steps (e.g., localized high points where shingles overlap), securing a mount to the rafters under the sheathing, and minimizing excess roof penetrations. More specifically, the embodiments of mounts disclosed herein may include portions that are rotatable (e.g., 180 degrees, etc.) about a clamp mounting face to avoid sealing over shingle course steps and/or to ensure alignment between the mount and a suitable anchor point (e.g., rafter, truss, etc.). In an embodiment, the rotation may occur about the height adjustment bolt along the center axis of the assembly. The attachment is asymmetric about this axis of rotation in that the distance to mounting holes present on each flange from the axis is different when rotated 180 degrees, allowing one row of mounting holes on either side to mount flat to a shingle course. Upon rotation, the installer may use a second set of installer accessible holes for mounting to the roof. The attachment may also implement a butyl pad to seal the holes drilled, instead of manually applied sealant, thereby minimizing inconveniences of carrying additional materials and extra steps for the installer.

The embodiments disclosed herein facilitate finding rafters below the decking (e.g., shingles and sheathing) by using a strategic hole pattern within the base of the mount. For example, in an embodiment, a mount may have a 3/4″ horizontal spacing and vertical offset between hole pairs to maintain minimum screw distances. Thus, during installation, the installer may align the center hole pair to the pre-drawn rafter line and place the first screw in the outer hole. If this screw does not hit the rafter, the installer may place a second screw in an adjacent hole. When a screw hits, the installer may add the second screw in that successful hole pair to add mounting strength. This results in a minimum of two screws per attachment and a maximum of four. By attaching the mounts to the rafters, the disclosed system benefits from the additional strength provided by the rafters, which in turn requires fewer mounts. Installing fewer mounts results in fewer roof penetrations. Other direct-to-deck systems, wherein mounts are attached solely to the decking, do not benefit from being attached to rafters and require more mounts, thus producing more roof penetrations. Additionally, in an embodiment, features for integrated wire management may be included.

Accordingly, one or more advantages of the disclosed mounts may include: elimination of extra sealing means and tilt associated with installing a mount over a shingle course step; reduction of cantilevering of load relative to screw mount points associated with a mount installed across a shingle course step; and reduction of the difficulty of finding rafters to use for installing roof mounts by allowing installers with a pattern resulting in a smaller margin for error when finding rafters, which will speed up installation, reduce roof penetrations, and reduce the amount of time an installer spends in a fall hazard area.

Notably, concepts for water sealing/waterproofing technologies for use with fasteners and attachments for solar PV systems for pitched-roof applications may also be applied to flat roofs.

Attachment components for supporting and securing either rail-mounted or rail-less mounted solar PV modules to pitched roof structures require sealing methods to prevent water ingress at the point where the roof covering has been penetrated by fasteners. Roof coverings may include asphalt shingle, tile, membrane, or metal roofs, among others.

While flashings have traditionally been used, market solutions to waterproof roof covering penetrations have expanded beyond flashing solutions. Such non-flashing solutions may case installation and increase speed of installation. Non-flashing scaling technologies may include butyl tape, sealant (e.g., one-component polymeric flowable sealant), non-flowable sealant, seals formed by mechanical means, or any other solution that would prevent water intrusion.

Concepts described herein may improve on existing water sealing/waterproofing technology for roof attachments by leveraging designs that improve one or more of: case of installation, installation speed, production cost, transportation cost, packaging considerations (e.g., smaller packaging design, less mess, less material for packaging), performance, and/or durability.

### Illustrative Embodiments

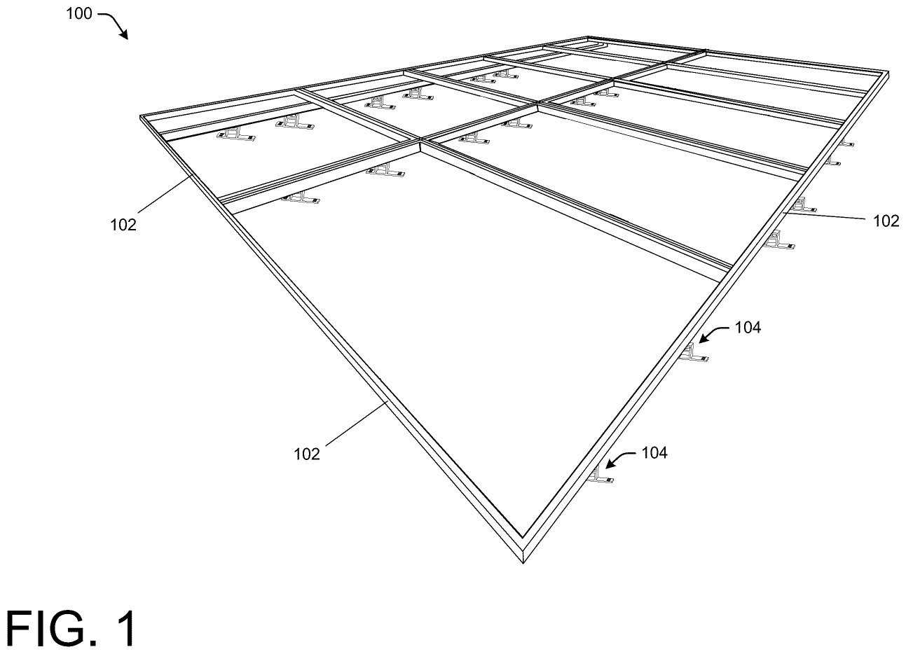

FIG. 1 illustrates a top-front perspective view of a solar panel system 100 (“system 100”), including one or more solar panel module frames(s) 102 (intended to secure a solar panel modules) and one or more mount(s) 104. In an embodiment, a solar panel module may have a top surface and a bottom surface wherein the top surface is oriented such that it is exposed to light and the bottom surface is oriented such that it faces the mounting surface (e.g., roof surface, ground surface, etc.), likewise with the frames 102 that surround the modules and are secured by the mounts 104. While FIG. 1 illustrates the system 100 being capable of securing a plurality of solar panel modules, the system 100 may secure only a single solar panel module as well. Regardless, as an example, the system 100 depicted here shows multiple frames 102 (for modules) may be disposed above rows of mounts 104. While the mounts 104 may be used for mounting solar panel modules, it is understood that there may be additional uses (e.g., different objects to mount) for one or more of the components of the mounts 104.

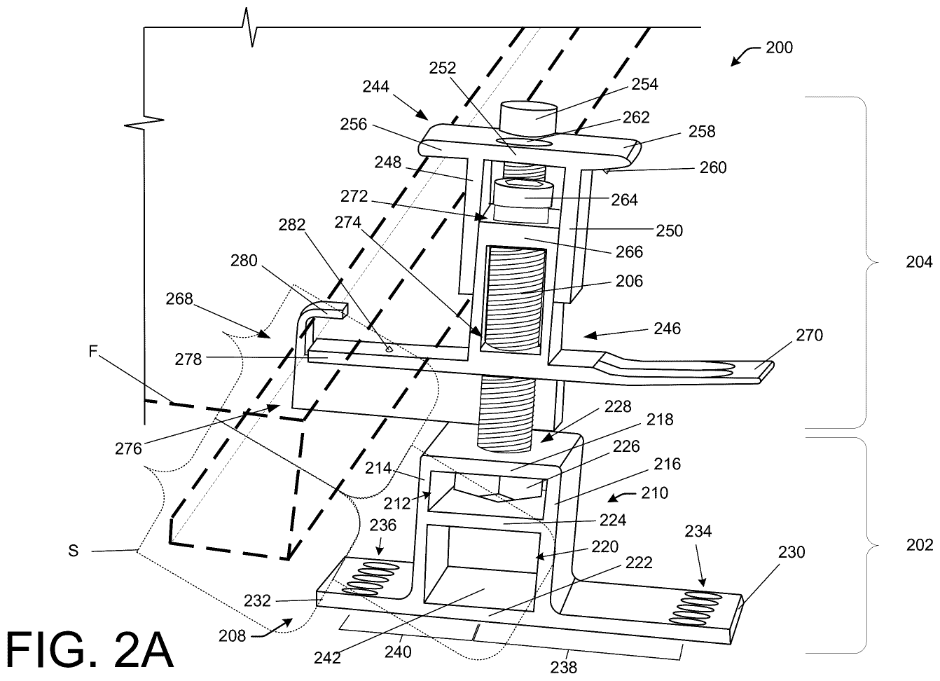

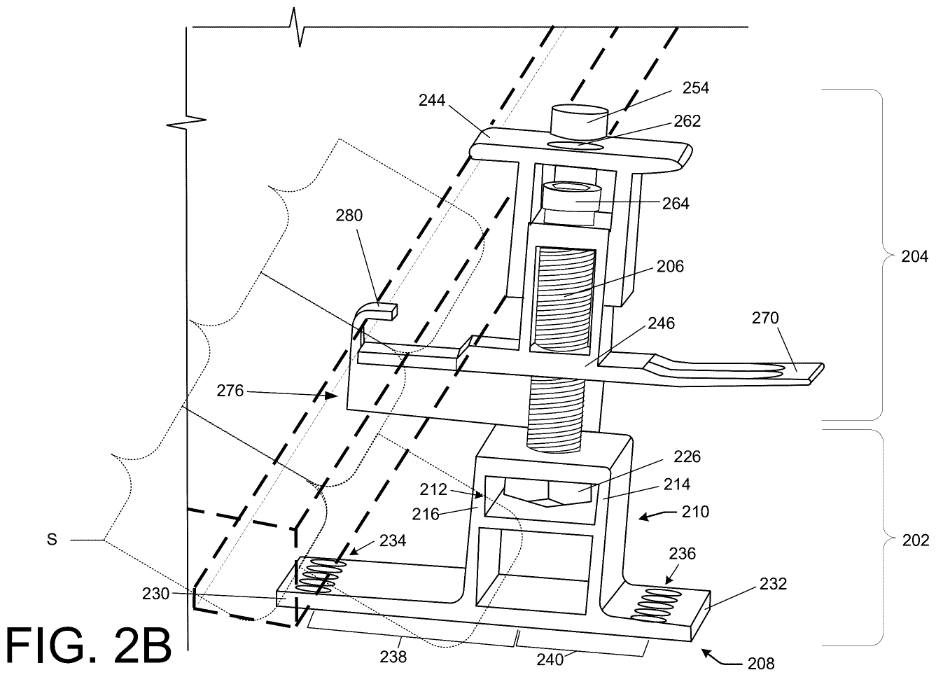

FIG. 2A illustrates an isometric side view of a rail-less roof attachment system 200 (“system 200”) paired with a solar panel module frame F (e.g., with a rectangular frame side having a return flange on the bottom side), which is shown in a secured position, using dashed thick lines to portray a skeletal outline for convenience in the description of the “soft-clamping” aspect of the disclosure.

In an embodiment, system 200 may include a base 202 and a clamp assembly 204 connected by a fastener 206 (e.g., bolt, machine screw, carriage bolt, or other suitable fastener). In an embodiment, the base 202 may rotate about the fastener 206 while the clamp assembly 204 remains stationary.

In an embodiment, the base 202 may include a horizontal portion 208, extending in a plane, and having a lower surface configured to abut a mounting surface (not expressly depicted, but implied beneath the horizontal portion 208). The base 202 may further include an integrally formed vertical portion 210 that protrudes from an upper surface of the horizontal portion 208. In other words, the vertical portion 210 protrudes in a direction transverse to the plane in which the horizontal portion 208 extends (e.g., a third direction).

The vertical portion 210 (which may also be referred to hereinafter as a first base portion) of the base 202 may include a cavity 212 (e.g., first cavity, void, hollow, through hole, etc.) defined, at least in part, by first side wall 214, second side wall 216, and top wall 218. The vertical portion 210 may further include a cavity 220 (e.g., second cavity, void, hollow, through hole, etc.) defined, at least in part by, the first side wall 214, the second side wall 216, a bottom wall 222, and a bridge wall 224, (which separates cavity 212 from cavity 220). In an embodiment, the cavity 212 may be configured/sized to receive a nut 226 that is accommodated on the fastener 206. The cavity 212 may also be configured such that the nut 226 does not rotate within the cavity 212. In an embodiment, the cavity 220 may be configured to accommodate electrical wires (not shown) passing therethrough. In an alternative embodiment (not shown), instead of a nut, the top wall 218 may include a threaded aperture 228 (threading not visible) extending therethrough configured to engage with the fastener 206.

In an embodiment, the horizontal portion 208 (which may also be referred to hereinafter as a second base portion) of the base 202 may include a long end 230 (e.g., first end) and a short end 232 (e.g., second end). The long end 230 may include at least one mounting hole (see row of mounting holes 234). As shown, when there is more than one mounting hole, the plurality of mounting holes may be arranged, for example, in a row of mounting holes 234 (e.g., first row of holes, apertures, divots, openings, marks, etc.). The short end 232 may likewise include one or more mounting holes (see row of mounting holes 236). Similar to the long end 230, when there is more than one mounting hole on the short end 232, the plurality of mounting holes may be arranged, for example, in a row of mounting holes 236 (e.g., second row of holes, apertures, divots, openings, marks, etc.). The mounting holes (in rows 234/236) extend through the horizontal portion 208 to open adjacent the mounting surface. In an embodiment, a distance 238 (e.g., first length, first distance, etc.) between the row of mounting holes 234 and a central point 242 of the vertical portion 210 may be greater than a distance 240 (e.g., second length, second distance, etc.) between the row of mounting holes 236 and the central point 242 of the vertical portion 210.

In an embodiment, the clamp assembly 204 may include an upper clamp portion 244 (which may also be referred to hereinafter as a first clamp portion) and a lower clamp portion 246 (which may also be referred to hereinafter as a second clamp portion). In an embodiment, the upper clamp portion 244 may be configured to engage with a top surface of a solar panel module frame, and the lower clamp portion 246 may be configured to engage with a bottom surface of a solar panel module frame. Thus, the upper clamp portion 244 and the lower clamp portion 246 function together to clamp a solar panel module frame therebetween. In an embodiment, the distance between the upper clamp portion 244 and the lower clamp portion 246 may be adjusted to accommodate the differing heights of a variety of sizes of solar panel modules/frames.

The upper clamp portion 244 may include a first side wall 248 and a second side wall 229 fixed in parallel by a top wall 252. A height adjustment assembly 254 extends through an aperture within the top wall 252 of the upper clamp portion 244 (the “aperture” for the height adjustment assembly is not visible as a portion of the height adjustment assembly 254 is shown extending therethrough). The upper clamp portion 244 further includes a first clamp wing 256, and a second clamp wing 258, extending respectively from opposite sides of the top wall 252. The first clamp wing 256 and the second clamp wing 258 are positioned to clamp down on the upper surface of adjacent solar panel frames being mounted therein.

In an embodiment, the second clamp wing 258 may include a convexity 260 (e.g., point, bulge, etc.) configured to scratch, mar, or otherwise compromise the coating of the solar panel module (e.g., scratch an anodized coating, remove a paint layer, etc.) to improve grounding (e.g., electrical grounding, electrical bonding, etc.). In an embodiment, the convexity 260 may be separate from the second clamp wing 258. For example, the convexity 260 may be a pin, set screw, or other object protruding from an aperture or cavity within the second clamp wing 258. In an embodiment not shown, the second clamp wing 258 may include a threaded aperture and the convexity 260 may include a set screw configured to engage with the threaded aperture within the second clamp wing 258, such that the set screw may extend past the surface of the second clamp wing 258 to scratch, mar, or otherwise compromise the coating of the solar panel module.

The upper clamp portion 244 may also include aperture 262 disposed in a top surface of the upper clamp portion 244. Aperture 262 may be sized to allow the threaded fastener 206 to pass through the upper clamp portion 244 into the lower clamp portion 246. It is also understood that aperture 262 may also be configured and/or sized to allow a tool (e.g., Allen wrench, screwdriver, t-wrench, torx-tip driver, etc.) to pass through in order to access and rotate the head 264 of the threaded fastener 206.

In an embodiment, the height adjustment assembly 254 may include a fastener configured to rotate within a threaded aperture such that rotating the fastener clockwise may increase the distance between the upper clamp portion 244 and the lower clamp portion 246 and rotating the fastener counterclockwise may decrease the distance between the upper clamp portion 244 and the lower clamp portion 246.

The lower clamp portion 246 may include a fastener section 266, a soft-clamping arm 268 (e.g., a first flange, ledge, support landing, rest, catch, etc. for securing/supporting a solar panel module frame), and a protrusion 270 (e.g., a second flange, ledge, support landing, rest, catch, etc. for securing/supporting a solar panel module frame on a side opposite the soft-clamping arm 268). In an embodiment, the soft-clamping arm 268 may extend laterally outward from the fastener section 266 (e.g., in a first direction), and the protrusion 270 may extend laterally outward from the fastener section 266 such that the protrusion 270 extends from a side that is opposite the soft-clamping arm 268 (e.g., in a second direction).

In an embodiment, the fastener section 266 may be configured to receive the fastener 206 such that the fastener 206 extends vertically through the lower clamp portion 246 via the fastener section 266. The fastener section 266 may include a first aperture 272 (e.g., top aperture, upper aperture, etc.) and a second aperture 274 (e.g., bottom aperture, lower aperture, etc.), neither of which are not visible in FIG. 2A since the fastener 206 is shown as extending through the first aperture 272 fastener 206 and the second aperture 274. In an embodiment, the first aperture 272, the second aperture 274, or both may be threaded to accommodate the fastener 206.

In an embodiment, the soft-clamping arm 268 may include a clamp element 276. In an embodiment, as discussed in greater detail below, the clamp element 276 may be slidable with respect to an integrally-formed, clamp support ledge 278 (e.g., flange, member, surface, etc.) that protrudes from the fastener section 266. The clamp support ledge 278 provides a structural attachment location for the clamp element 276. The soft-clamping arm 268 may further include a return flange 280 (e.g., hook, clasp, etc.) that is configured to extend from the end of the clamp element 276 backwards across the clamp support ledge 278, and toward the clamp assembly 204. By so doing, when installed, the return flange 280 is positioned to extend toward the frame edge of a solar panel module, such that the return flange 280 is slidably positionable between two positions. With the return flange 280 in a first position, a solar panel module frame freely passes to fit against the clamp support ledge 278 and laterally within the space between the return flange 280 and the first side wall 248. With the solar panel module frame in place, the clamp element 276 may be laterally shifted (e.g., pulled, slid, bias released, etc.) into a second position of the return flange 280, so that the return flange 280 extends over the inside of the frame, and thereby “soft” clamps the solar panel module to the rail-less roof attachment system 200. In other words, as indicated above, it is a “soft” clamp because it is secured to the solar panel frame, yet simply and quickly releasable and repositionable—without needing a tool—along the solar panel frame, if needed.

In an embodiment, the clamp support ledge 278 may include a convexity 282 (e.g., point, bulge, etc.) protruding from an upper surface of the clamp support ledge 278 and configured to scratch, mar, or otherwise compromise the coating of the solar panel module (e.g., scratch an anodized coating, remove a paint layer, etc.) to improve grounding (e.g., electrical grounding, electrical bonding, etc.). In an embodiment, the convexity 282 may be separate from the clamp support ledge 278. For example, the convexity 282 may be a pin, set screw, or other object protruding from an aperture or cavity within the clamp support ledge 278. In an embodiment, the clamp support ledge 278 may include a threaded aperture and the convexity 282 may include a set screw configured to engage with the threaded aperture within the clamp support ledge 278 such that the set screw may extend past the surface of the clamp support ledge 278 to scratch, mar, or otherwise compromise the coating of the solar panel module.

In an embodiment, the fastener section 266 of the lower clamp portion 246 may be configured to accommodate the threaded fastener 206. Moreover, the threaded fastener 206 may be oriented such that a first end of the threaded fastener 206 remains above the lower clamp portion 246, while a second end of the threaded fastener 206 engages with a nut 226 within the base 202. In an embodiment, the rotation of the threaded fastener 206 within the nut 226 may cause the clamp assembly 204 to tighten against the base 202. This rotation is possible while still permitting the soft-clamping arm 268 maintain engagement with the underside frame edge of a solar panel module.

Similarly, in an embodiment, the base 202 may be rotatable as needed (e.g., 90 degrees, 180 degrees, etc.), again without interference from structure or function of the soft-clamping arm 268. That is, the base 202 may be rotated 180 degrees while the clamp assembly 204 remains in the same location (e.g., stationary) relative to a central vertical axis within the base 202. For example, in an embodiment, the clamp assembly may be oriented to attach to a solar panel module wherein the distance from the edge of the solar panel module to the nearest shingle S course step is large. In such cases where the shingle S course step is not near the edge of the solar panel module, it may be advantageous for the base 202 to be oriented such that the long end 230 extends to the shingle course step, as is depicted in FIG. 2A.

FIG. 2B illustrates an isometric front view of the rail-less roof attachment system of FIG. 2A (“system 200”) with the base 202 rotated 180 degrees relative to the base 202 depicted in FIG. 2A. For example, in an embodiment, the clamp assembly 204 may be oriented to attach to a solar panel module frame, and the distance from the edge of the solar panel module to the nearest shingle S course step is small. In such cases where the shingle S course step is near the edge of the solar panel module, it may be advantageous for the base 202 to be oriented such that the short end 232 extends to the shingle S course step, as is depicted in FIG. 2A. Accordingly, the long end 230 may partially extend under the solar panel module.

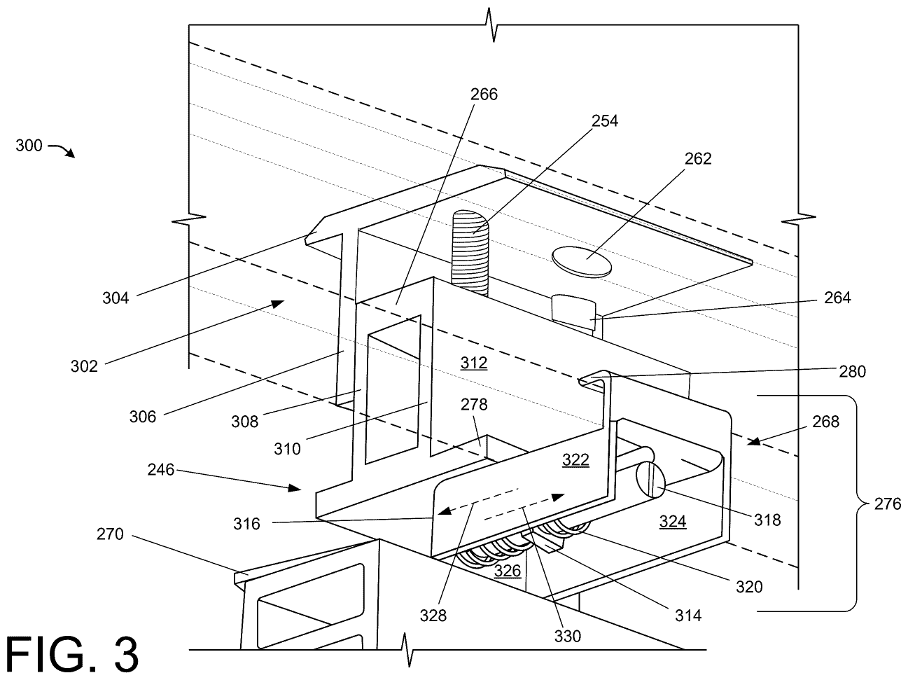

FIG. 3 illustrates an isometric bottom-side view of the rail-less roof attachment system and clamp assembly 300 with a single-sided upper clamp portion 302. Moreover, note that the view is from the opposite direction as both of FIGS. 2A and 2B.

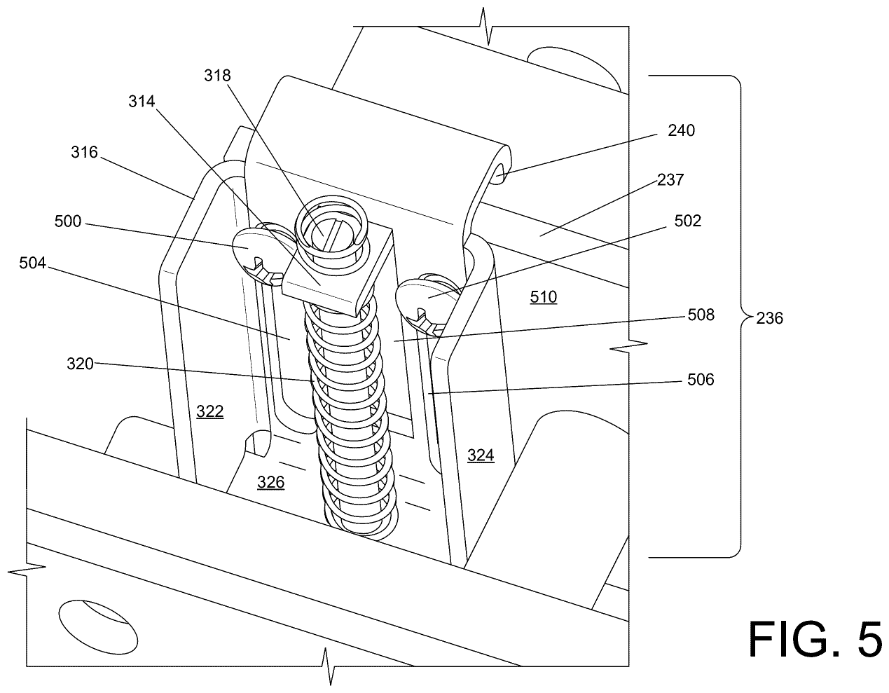

In an embodiment, the single-sided upper portion 302 may include a top 304 and a side wall 306 that integrally intersects the top 304. The lower clamp portion 246 may be similar or the same as the lower clamp portion 246 discussed with respect to FIGS. 2A and 2B, (including the fastener section 266, the soft-clamping arm 268, and the protrusion 270 for example). In more detail, the fastener section 266 may be defined structurally by a side wall 308 (e.g., first side wall, etc.) and a side wall 310 (e.g., second side wall, etc.) opposite the side wall 308. The outside surface 312 of side wall 310 is configured to engage with an outside surface of a frame of a solar panel module. The clamp support ledge 278 extends from the outside surface 312 of the side wall 310 in a direction away from the side wall 310. Additionally, a tab 314 protrudes downward from the clamp support ledge 278, through a surface (in a slot, see FIG. 5, discussed hereinbelow) of the clamp element 276, and toward the base 202.

In an embodiment, the clamp element 276 may include a body 316, a retaining rod 318, and a biasing member 320 (e.g., coil spring, etc.). The body 316 is secured to an underside of the lower clamp portion 246. In an embodiment, the body 316 may include a first side wall 322, a second side wall 324 opposite the first side wall 322, and a rear wall 326 that extends from the first side wall 322 to the second side wall 324. The retaining rod 318 may be anchored (e.g., screwed in, pressed in, screwed through, etc.) in the rear wall 326 and extend along the length of the body 316 between the first side wall 322 and the second side wall 324 and through an aperture within the tab 314.

In an embodiment, the clamp element 276 may be extended and/or retracted slidingly, in a lateral direction to soft-clamp to the solar panel module frame. Thus, the clamp element 276 may be positioned against a side of the solar panel module and the return flange 280 (e.g., hook) may be wrapped (e.g., curve, bent, etc.) around the inside lip/flange (e.g., edge, shelf, ledge, etc.) of the underside or the bottom surface of the solar panel module frame. In an embodiment, the clamp element 276 may slide in the direction 328 or the direction 330, as required, for the return flange 280 to be engaged with the solar panel module frame. For example, a solar panel module may be positioned within the system 200 while the clamp element 276 is fully extended in the direction 330 such that the side of the solar panel module abuts against the side wall 310 and the clamp support ledge 278.

In an embodiment, prior to solar panel module installation, the clamp element 276 may be fully slid in the direction 328. The clamp element 276 of the soft-clamping arm 268 may be pressed, by hand, in the direction 330 to an adequate width for accommodating a solar panel module, as explained above. As the clamping portion moves in the direction 330, a spring 320 may compress between the rear wall 326 and the tab 314, thereby creating a biasing force. When the solar panel module is in a proper position for installation (e.g., against the outside surface 312 and the clamp support ledge 278) the clamping portion may be released. The biasing force generated by the compression of spring 320 may force the clamp element 276 to slide in the direction 330, thereby securing (or “soft-clamping”) the solar panel module between the side wall 310 and the clamp element 276. In an embodiment, when the clamping portion slides in the direction 328 or the direction 330 clamp element 276, the retaining rod 318, being anchored to the rear wall 326 of the body 316, may likewise move with the body 316. While the retaining rod 318 moves in the direction 328 or 330, the retaining rod may freely move through the aperture in the tab 314.

In an embodiment the spring 320 may have a first end and a second end. In an embodiment, the spring 320 may have a first end that is anchored to the tab 314 and a second end that extends from the rear wall 326 of the clamp element 276 to the tab 314. In an embodiment, at least a portion of the spring 320 may extend through the tab 314. In an alternative embodiment, the entire spring 320 may be disposed between the rear wall 326 and the tab 314.

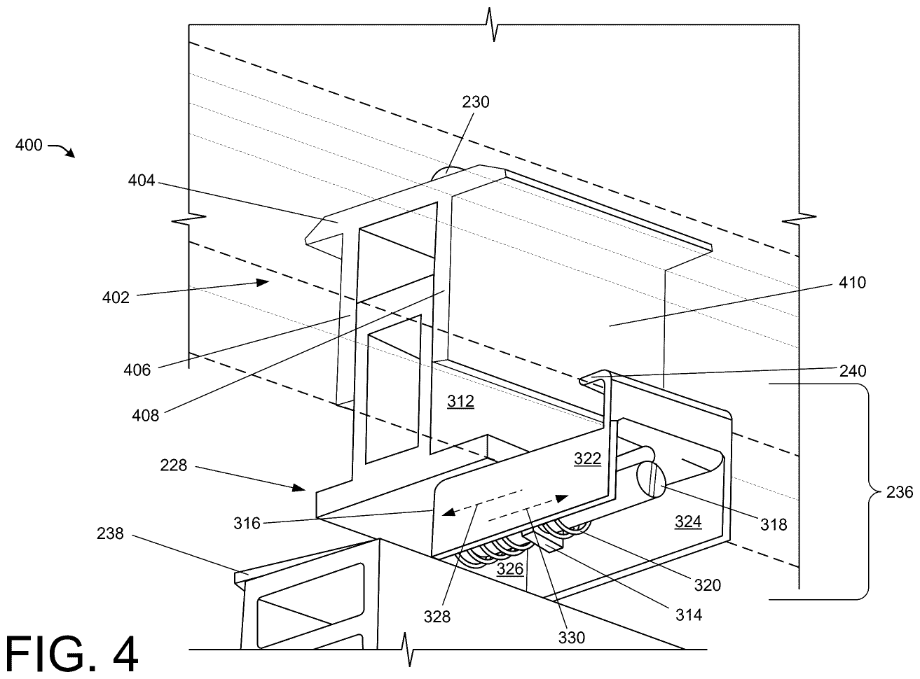

FIG. 4 illustrates an isometric bottom-side view 400 of the rail-less roof attachment system of FIG. 2A (“system 200”) with a double-sided upper portion 402.

In an embodiment, the double-sided upper portion 402 may include a top 404, a side wall 406 (e.g., a first side wall) extending in a direction that is perpendicular to the top 404, and a side wall 408 (e.g., a second side wall) extending in a direction that is perpendicular to the top 404 and parallel to the side wall 406. The side wall 408 may include an outside surface 410 that is configured to planarly engage with a side surface of a solar panel module, when installed.

The operation of the system 200 utilizing the double-sided upper portion 402 is similar to the operation of system 200 utilizing the single-sided upper portion 302. In an embodiment utilizing the double-sided upper portion 402, the solar panel module may be positioned such that the side of the solar panel module abuts against the outside surface 410 of the side wall 408. The clamp element 276 may be pressed, by hand, in direction 328 towards the side wall 408, thereby securing (or “soft-clamping”) the solar panel module between the side wall 408 and the clamp element 276.

FIG. 5 illustrates a close-up of an isometric bottom-side view of the clamp element 276 of the clamp assembly of FIG. 2A.

In an embodiment, the clamp element 276 may include a first fastener 500, a second fastener 502, a first fastener slot 504, a second fastener slot 506, and a tab slot 508. The first fastener 500 and the second fastener 502 may be screwed into a bottom surface 510 of the clamp support ledge 278. The first fastener slot 504 may be sized to accommodate a shaft of the first fastener 500. The second fastener slot 506 may be sized to accommodate the shaft of the second fastener 502. The tab slot 508 may be sized to accommodate the tab 314. In an embodiment, the tab 314 may extend from the bottom surface 510 of the clamp support ledge 278 through the tab slot 508.

In an embodiment, the first fastener slot 504, the second fastener slot 506, and the tab slot 508 may extend along the length of the body 316. In an embodiment, when the clamping portion is fully inward (e.g., the spring 320 is fully extended) the first fastener 500, the second faster 502, and the tab 314 may be at a first end of the first fastener slot 504, second fastener slot 506, and tab slot 508, respectively. When the clamp element 276 is fully outward (e.g., the spring 320 is fully compressed), the first fastener 500, the second faster 502, and the tab 314 may be at a second end of the first fastener slot 504, second fastener slot 506, and tab slot 508, respectively.

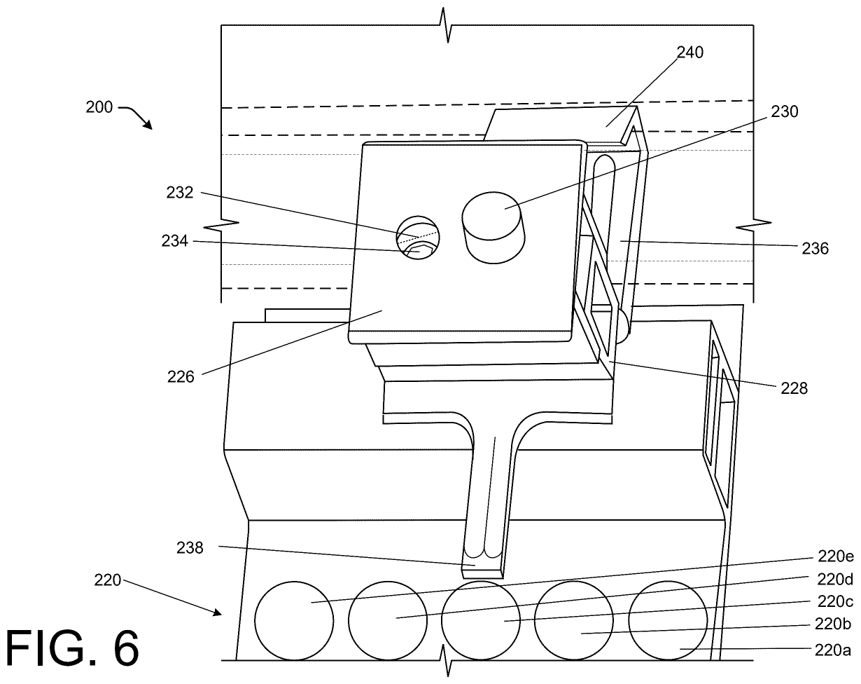

FIG. 6 illustrates an isometric top view of the rail-less roof attachment system of FIG. 2A (“system 200”). In an embodiment, the row of mounting holes 236 may include one or more individual mounting holes (236a, 236b, 236c, 236d, 236c). In an embodiment, the row of mounting holes 236 may include a 0.75″ hole spacing hole pattern between five mounting holes (e.g., individual mounting holes 236a, 236b, 236c, 236d, 236e) to allow for some error (e.g., +/−1.5″) in the drawn rafter line, which may guarantee that at least one of the individual mounting holes (236a, 236b, 236c, 236d, 236c) may line up with a rafter within a total 3″ range. By ensuring that at least one of the individual mounting holes (236a, 236b, 236c, 236d, 236c) lines up with a rafter, the base 202 may be securely fastened to a rafter. It is understood that the row of mounting holes 234 may also include a 0.75″ hole spacing hole pattern between five mounting holes (e.g., individual mounting holes 234a, 234b, 234c, 234d, 234c).

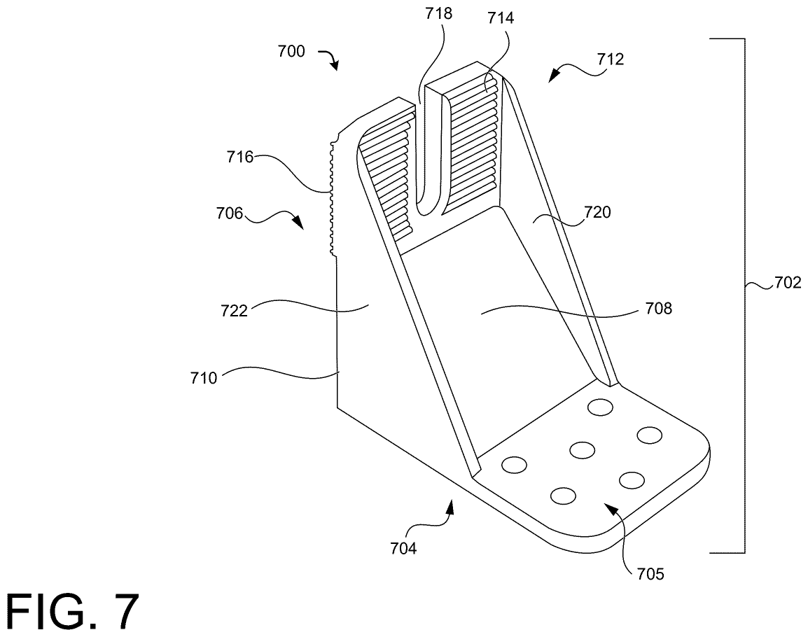

FIG. 7 illustrates an isometric back-side view of an embodiment of a rail-less roof attachment apparatus 700 (“mount 700”). In an embodiment, the mount 700 includes a body 702 which includes a horizontal portion 704 and a vertical portion 706. The mount 700 may be made from resin, plastic, aluminum, or any other suitable material.

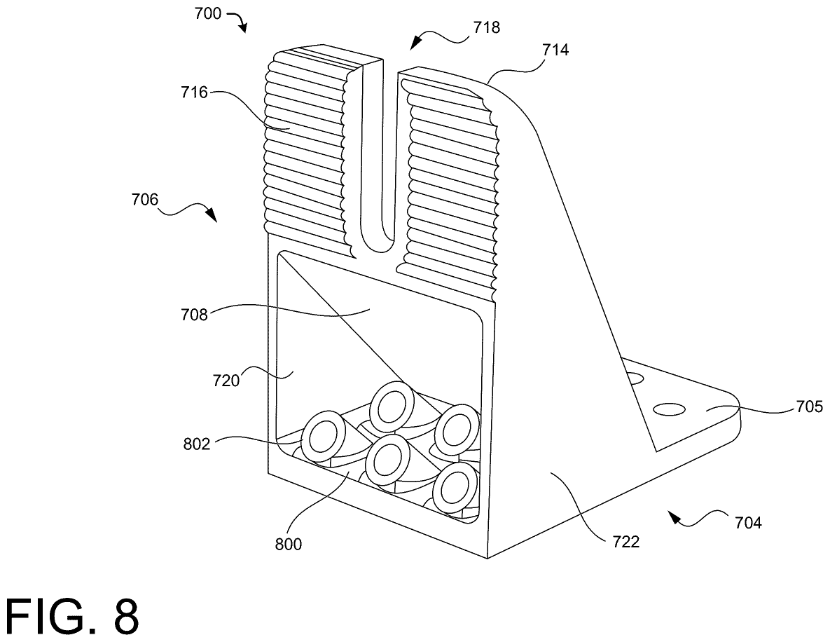

The horizontal portion 704 may include a primary screw hole pattern 800 (not shown in FIG. 7, see FIG. 8) on a first side, wherein the holes extend transversely to the horizontal portion 704 and include hole guides 802 that extend above the planar surface of the horizontal portion 704, and a secondary screw hole pattern 705 on a second side, wherein the holes are directed perpendicularly through the horizontal portion 704. The secondary screw hole pattern 705 may be utilized, for example, when the attachment is rotated 180 degrees. Both hole patterns may have, for example, in an embodiment, a 0.75″ horizontal spacing between each set of two holes, for easier rafter finding as previously discussed.

The vertical portion 706 includes a lower part 708 that extends transversely from the horizontal portion 704 towards an edge 710 of the body 702. The pitch of the lower part 708 may be the same or different than a pitch of the transversely extending primary screw hole pattern 800 with respect to the horizontal portion 704. The vertical portion 706 further includes an upper part 712 that extends transversely upward from the lower part 708. The upper part 712 serves as a post-row height adjustment area. That is, the upper part 712, having a first side (e.g., inside surface) 714 and a second side (e.g., outside surface) 616, may include a slot 718 which extends through a thickness direction (e.g., through first side 714 and second side 716) and longitudinally in a vertical direction to accommodate vertical adjustment of the elements to be attached to the mount 700. Moreover, the first side 714 and the second side 716 may include a textured surface (e.g., teeth, grooves, etc.) to assist in gripping to attached elements. The slot 718 may further allow for the mount 700 to slide off the clamp, rotate, and reattach in one step in order to avoid shingle course steps.

The body 702 of the mount 700 may further support the sidewalls 720, 722, which flank the vertical portion 706 on opposite sides of the body 702, extending from the horizontal portion 704 on both the lower part 708 and the upper part 712. Thus, the support sidewalls may provide lateral and vertical strength to the mount 700.

FIG. 8 illustrates an isometric front-side view of the rail-less roof attachment apparatus 700 (“mount 700”) of FIG. 7. In an embodiment, as indicated above, the secondary hole pattern 800 may include the hole guides 802 that may extend like a tubular sleeve above the planar surface of the horizontal portion 704. In an embodiment, the hole guides 802 may be positioned within a range of 45-75 degrees, for example, at an angle of 60 degrees relative to the horizontal portion 704. Such angled positioning may allow for an installer to access and/or install screws underneath the mount, penetrate the roof deck, and ensure that the screws are torqued after penetration, without over angling the holes such that the component slides when screws rotate to initiate a hole.

In an embodiment, the primary hole pattern 705 and the secondary hole pattern 800 may include one or more holes, respectively, that are staggered spatially in a horizontal plane and/or angled at a desired pitch.

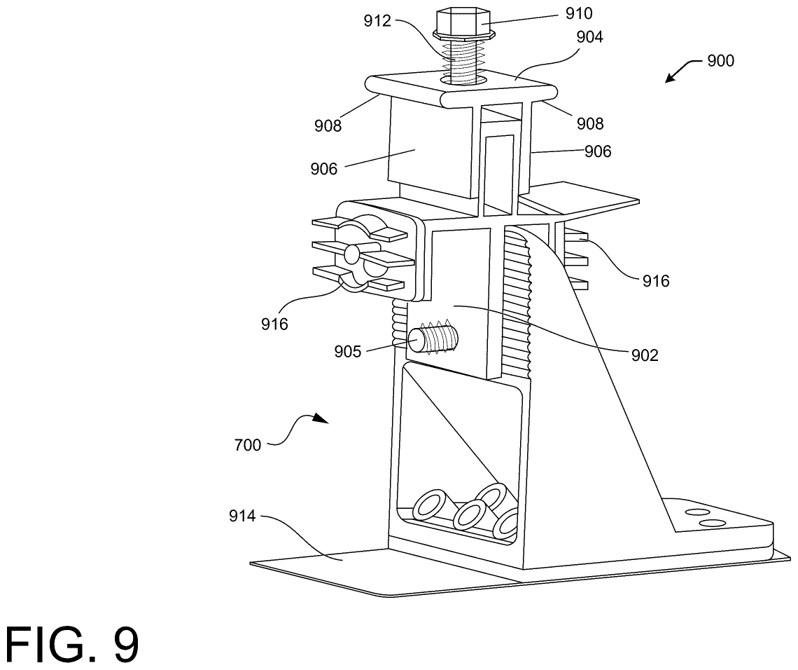

FIG. 9 illustrates an isometric front view of a rail-less roof attachment system and a clamp assembly. As shown in FIG. 9, a clamp assembly 900 may be an element that attaches to the mount 700. Clamp assembly 900 may include a lower clamp member 902 and a corresponding upper clamp member 904.

Lower clamp member 902 may include fastener 905 and an aperture configured to receive fastener 905 (the “aperture” is not visible as the fastener 905 is shown extending therethrough). The fastener 905 and aperture may be positioned within the lower clamp member 902 such that the aperture aligns with the slot 718, such that the fastener 905, when extending through the aperture, will extend through the slot 718. In an embodiment, the aperture within the lower clamp member 902 may be configured to engage with the fastener 905 (e.g., the aperture may be threaded). The fastener 905 and the aperture within the lower clamp member 902 may be configured such that, via rotational movement of the fastener 905 within the lower clamp member 902, the lower clamp member 902 is tightened against the vertical portion 706 of the mount 700.

Upper clamp member 904 may include one or more side surfaces 906, a top surface 908, a fastener 910 and a spring 912. In an embodiment, side surface 906 may be configured to planarly engage with a side of a solar panel module. The top surface 908 may be configured to engage with a top surface of a solar panel module. In an embodiment, fastener 910 may be disposed within an aperture (the “aperture” is not visible as the fastener 910 is shown extending therethrough) disposed in a top surface of the upper clamp member 904 such that, via rotational movement of the fastener 910 within the upper clamp member 904, the upper clamp member 904 is raised relative to the lower clamp member 902 in order to accommodate a height of a solar panel module. In an embodiment, the aperture within the top surface of the upper clamp member 904 may be configured to engage with the fastener 910 (e.g., the aperture may be threaded). In an embodiment, the spring 912 may be used to provide a soft clamping force to clamp assembly 900 to hold the clamp assembly 900 in place while allowing the installer to slide the clamp assembly 900 along the module edge to align the mount 700 to the rafters.

In an embodiment, a butyl pad 914 with a pull tab may be included to seal the mount 700 to the mounting surface. The pull tab on the butyl pad 914 may allow for quick and easy removal of a release liner during installation. In an embodiment, one or more wire management channels 916 may attach (e.g., snap, affix, etc.) to either side of the clamp assembly 900 (e.g., on flanges of the lower clamp member 902).

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A rail-less roof mounting apparatus comprising:
a clamp assembly including:
a first clamp portion configured to clamp against a top surface of a solar panel module, and
a second clamp portion configured to engage the first clamp portion, the second clamp portion including:
a fastener section configured to receive a fastener,
a clamp support ledge extending in a first direction, having a first surface configured to planarly engage with a bottom surface of the solar panel module, the clamp support ledge having:
a soft-clamping arm attached to a second surface of the clamp support ledge, and
a protrusion having a surface configured to planarly engage with a bottom surface of a second solar panel module, the protrusion extending from the fastener section in a second direction opposite the first direction; and
a base that is rotatable with respect to the clamp assembly, wherein
the fastener extends through the clamp assembly and the base, the fastener engaging a nut therein.

2. The rail-less roof mounting apparatus of claim 1, wherein the soft-clamping arm includes:
a body, including:
a first side wall,
a second side wall opposite the first side wall, and
a rear wall extending between the first side wall and the second side wall, a retaining rod anchored to the rear wall of the body,
a tab extending from the second surface of the clamp support ledge in a fifth direction away from the clamp support ledge, the tab having an aperture configured to accommodate the retaining rod, and
a biasing member extending between the rear wall of the body and the tab.

3. The rail-less roof mounting apparatus of claim 1, wherein the base includes:
a first end includes a first row of first mounting holes, and
a second end includes a second row of second mounting holes.

4. The rail-less roof mounting apparatus of claim 3, wherein:
the first row of first mounting holes includes a first individual mounting hole spaced approximately 3/4″ from a second individual mounting hole, and
the second row of second mounting holes includes a first individual mounting hole spaced approximately 3/4″ from a second individual mounting hole.

5. The rail-less roof mounting apparatus of claim 1, wherein the base includes a first base portion and a second base portion, the first base portion including:
a first side wall extending in a third direction away from the second base portion,
a second side wall opposite the first side wall extending in the third direction,
a top wall extending from a top edge of the first side wall to a top edge of the second side wall, and
a bridge wall extending from an inside surface of the first side wall to an inside surface of the second side wall, wherein the nut is disposed in a cavity defined by the first side wall, the second side wall, the top wall, and the bridge wall.

6. The rail-less roof mounting apparatus of claim 1, wherein the base includes:
a first base portion having a cavity accommodating a nut therein, and
a second base portion including:
a first end extending from the first base portion in a first direction, the first end having a first length, and the first end having a first mounting hole, and
a second end extending from the first base portion in a second direction opposite to the first direction, the second end having a second length that is shorter than the first length, and the second end having a second mounting hole.

7. The rail-less roof mounting apparatus of claim 1, the first clamp portion of the clamp assembly including:
a first side wall having a first end and a second end opposite the first end,
a first clamp wing extending outwardly from the first end of the first side wall,
a second side wall having a first end and a second end opposite the first end, the second side wall being opposite the first side wall,
a second clamp wing extending outwardly from the first end of the second side wall, and
a top wall extending from the first end of the first side wall to the first end of the second side wall, the top wall including an aperture configured to accommodate the fastener.

8. A rail-less roof mounting system, comprising:
a clamp assembly including:
a first clamp portion,
a second clamp portion configured to receive the first clamp portion, the second clamp portion including:
a clamp support ledge having a first surface configured to engage with a bottom surface of a solar panel module,
a soft-clamping arm attached to a second surface of the clamp support ledge, and
a return flange extending from an end of the soft-clamping arm in a direction toward the first clamp portion, and
a height adjustment assembly configured to adjust a distance between the first clamp portion and the second clamp portion;
a base that is rotatable relative to the clamp assembly; and
a fastener extending through the clamp assembly and the base, the fastener engaging a nut therein.

9. The rail-less roof mounting system of claim 8, wherein the soft-clamping arm includes:
a body, including:
a first side wall,
a second side wall opposite the first side wall, and
a rear wall extending between the first side wall and the second side wall,
a tab extending from the second surface of the clamp support ledge in a second direction away from the clamp support ledge, the tab having an aperture configured to accommodate a retaining rod, and
a biasing member extending between the rear wall of the body and the tab.

10. The rail-less roof mounting system of claim 8, the height adjustment assembly including:
a threaded aperture passing through a first wall of the first clamp portion, and
a second fastener having a first end and a second end, the second end passing through the threaded aperture such that:
the first end of the second fastener engages the first clamp portion, and
the second end of the second fastener engages the second clamp portion.

11. The rail-less roof mounting system of claim 10, wherein rotation of the second fastener relative to the first clamp portion increases or decreases a distance between the first clamp portion and the second clamp portion.

12. The rail-less roof mounting system of claim 8, wherein the base is rotatable around the fastener such that the base may rotate while the clamp assembly remains stationary.

13. The rail-less roof mounting system of claim 8, the soft-clamping arm further including a return flange configured to curve around a ledge of the solar panel module.

14. The rail-less roof mounting system of claim 8, wherein:
the first clamp portion includes:
a side wall configured to engage with a lateral edge of a first solar panel module,
a first clamp wing extending from the side wall outwardly from the side wall, the first clamp wing configured to engage with a top surface of the first solar panel module, and
a second clamp wing configured to engage with a top surface of a second solar panel module, the second clamp wing extending outwardly from the first clamp wing, and
a side wall of the second clamp portion is configured to engage with a lateral edge of the second solar panel module.

15. A rail-less roof mounting system comprising:
a rail-less roof mounting apparatus, including:
a clamp assembly, including:
a clamp support ledge having a first surface configured to engage with a bottom surface of a solar panel module, and
a soft-clamping arm attached to a second surface of the clamp support ledge, the soft-clamping arm including:
a first side wall,
a second side wall opposite the first side wall,
a rear wall extending between the first side wall and the second side wall,
a tab extending from the second surface of the clamp support ledge in a direction away from the clamp support ledge, the tab having an aperture configured to accommodate a retaining rod, and
a biasing member extending between the rear wall and the tab;
a base that is rotatable with regard to the clamp assembly, and
a fastener extending through the clamp assembly and the base, the fastener engaging a nut therein.

16. The rail-less roof mounting system of claim 15, wherein the first surface of the clamp support ledge includes a point configured to electrically bond the solar panel module to the clamp assembly.

17. The rail-less roof mounting system of claim 16, wherein the clamp assembly includes:
a fastener section configured to accommodate the fastener therethrough, the fastener section including:
a first side wall extending in a third direction,
a second side wall extending in the third direction,
a top wall having a first aperture therethrough, the top wall extending from a first end of the first side wall to a first end of the second side wall in a fourth direction transverse to the third direction, and
a fourth wall having a second aperture therethrough, the fourth wall extending from a second end of the first side wall to a second end of the second side wall in the fourth direction.

18. The rail-less roof mounting system of claim 15, wherein the base includes a first base portion and a second base portion, the first base portion including:
a first cavity defined by:
a first side wall extending in a third direction away from the second base portion,
a second side wall opposite the first side wall extending in the third direction,
a top wall having an aperture therethrough, the top wall extending from a first end of the first side wall to a first end of the second side wall, and
a bridge wall extending from an inside surface of the first side wall to an inside surface of the second side wall, wherein the nut is disposed in the first cavity, and
a second cavity defined by:
the first side wall,
the second side wall,
the bridge wall, and
a bottom wall extending from a second end of the first side wall opposite the first end of the first side wall in the third direction to a second end of the second side wall opposite the first end of the second side wall.

19. The rail-less roof mounting system of claim 18, wherein the second cavity is configured to accommodate electrical wiring.

20. The rail-less roof mounting system of claim 15, wherein the clamp assembly further includes a first clamp portion and a second clamp portion, the second clamp portion including:
the clamp support ledge, and
the soft-clamping arm.
